(19) United States
(12) Patent Application Publication
(10) Pub. No.: US 2006/0139736 A1
(43) Pub. Date: Jun. 29, 2006

(54) Optical receiver

(75) Inventor: Takayuki Shimizu, Osaka-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/299,698

(22) Filed: Dec. 13, 2005

(30) Foreign Application Priority Data
Dec. 28, 2004 (JP) 2004-381759

(51) Int. Cl. G02F 2/00; H04N 7/173; H04N 5/44

(52) U.S. Cl. 359/325; 348/725; 725/100; 725/129

(57) ABSTRACT

In an optical receiver of the present invention, a signal C generated by converting a low-frequency current component of a current signal generated in a light sensing device and a signal G outputted by a duty ratio detecting circuit that detects a duty ratio of an output of a signal process circuit are processed in an AND circuit, and a signal H is outputted. The signal H is delayed in a delay circuit, and an output signal of the delay circuit is used to control an output control circuit that switches on or off an output of a signal process circuit.

This Nonprovisional application claims priority under 35 U.S.C. §119(a) on Patent Application No. 381759/2004 filed in Japan on Dec. 28, 2004, the entire contents of which are hereby incorporated by reference.

### FIELD OF THE INVENTION

The present invention relates to an optical receiver that converts an optical signal into an electronic signal.

### BACKGROUND OF THE INVENTION

Conventionally, optical receivers that convert an optical signal into an electronic signal have been widely used. Especially optical fiber links have been popularly used for musical devices among households, and a light receiving and emitting device for optical fiber links that inputs and outputs an optical digital signal to CD, MD, DVD players, amplifiers and the like is used. Recently, light receiving and emitting devices for optical fiber links are popularly used for transmitting music signals to portable devices such as notebook PCs, portable phones, or MP3 players. Consequently, there has been a demand for reduction of power consumed by devices for optical fiber links in terms of extending duration of batteries.

Further, optical fibers are excellent in lightness and noise resistance, and in-vehicle optical fiber links such as MOST (Media Oriented Systems Transport) or IDB1394 are available for practical use. Low consumption of current, therefore, is demanded.

FIGS. 22 and 23 respectively illustrate a conventional optical receiver that detects presence or absence of an input optical signal and changes a mode from and to an operation mode and a standby mode.

FIG. 22 shows a structure disclosed in Japanese Unexamined Patent Publication No. 2002-280971 (published on Sep. 27, 2002). The conventional optical receiver in FIG. 22 includes a light sensing device PD-1 dedicated for detecting an optical signal, and an amplifier circuit AMP-1. Based upon an output signal of a comparator COMP-1 that identifies an output level of the amplifier circuit AMP-1, a power supply circuit 103 switches on or off supply of power that is supplied to an amplifier circuit AMP-2 and a comparator COMP-2, both of which are for processing signal. In other words, when an optical signal enters, a receiving circuit (optical signal detecting circuit) 101 for detecting entering light switches a mode of a receiving circuit (optical signal detecting circuit) 102 for processing a signal from a standby mode to an operation mode.

FIG. 23 shows a structure disclosed in Japanese Unexamined Patent Publication No. 2000-078091 (published on Mar. 14, 2000). In FIG. 23, another conventional optical receiver having a shut-down function is illustrated. In the optical receiver, when an optical signal enters a photodiode, voltage is generated by R1. Due to the voltage, MP1 and MP2 of a P-channel MOSFET become ON, and an amplifier circuit AMP-1 and a wave shaping circuit COMP-2 are supplied with power, thereby switching a mode of a receiving circuit to an operation mode. This, however, cannot be applied to a receiving circuit in which an anode of the photodiode is connected to a ground.

In the structure illustrated in FIG. 22, the amplifier circuit AMP-1 for detecting light and the comparator COMP-1 need to be activated even when no optical signal is entering. Therefore, current is passed during standby time.

Moreover, because an additional photodiode for detecting an optical signal needs to be prepared, the number of components increases, resulting in a disadvantage of an enlarged chip area in a case of OPIC (Optical IC).

### SUMMARY OF THE INVENTION

The present invention is in view of the above problems, and has as an object to realize an optical receiver that can reduce running current during standby time.

An optical receiver of the present invention includes: a signal process circuit that carries out an output process of data received by a light sensing device; an activation control circuit, (a) for determining, based upon a level of a voltage of a low-frequency current component of a current signal generated by the light sensing device, whether or not data is being received, and (b) for outputting a signal C, which, when data is being received, is a signal CA indicating that data is being received, so that the output of the signal CA activates the signal process circuit, and when no data is being received, is a signal CB indicating that no data is being received; an operation determining circuit for determining, based upon a level of an output signal of the signal process circuit, whether data is being received, and outputs a signal G which, when data is being received, is a signal GA indicating that data is being received and when no data is being received, is a signal GB indicating that no data is being received; a control signal output circuit for outputting a control signal according to comparison between a predetermined boundary value TH and a determination signal that the control signal output circuit generates, the control signal being such that at least in a period in which the signal C is CA, the control signal is an ON signal if the comparison shows that a direction from the boundary value TH to the determining signal currently generated is a direction D1, or is an OFF signal if the comparison shows that the direction from the boundary value TH to the determining signal currently generated is a direction D2, where the direction D1 is one of an increasing direction and a decreasing direction and the direction D2 is the other one of the increasing direction and the decreasing direction, and where (a) if in the period in which the signal C is CA, a first change occurs that is a change of the signal G from GB to GA, the determination signal changes a level thereof in the direction D1 at such a level change rate that the level of the determination signal is changed at least beyond the boundary value TH within the period in which the signal C is CA, (b) if a second change occurs that is a change of the signal G from GA to GB after the first change, the determination signal changes the level thereof, at least within the period in which the signal C is CA, in the direction D1 if the signal G is GA or in the direction D2 if the signal G is GB, but the determination signal changes the level thereof at such a level change rate that the level of the determination signal is changed not beyond the boundary value TH within the period in which the signal C is CA, and (c) after the second change, the determination signal changes the level thereof so that the level of the determination signal is beyond the boundary value TH after the signal C changes from CA to CB; and an output control circuit for switching, according to the control signal from the control signal output circuit, whether or not the light receiving device outputs an output signal of the signal process circuit therefrom.

In the above structure, the activation control circuit divides low-frequency current and high-frequency current of a current signal generated in the light sensing device, the low-frequency current is converted into voltage, and an output thereof activates the signal process circuit. Further, when a result of conversion of the low-frequency current into voltage is below a predetermined level, in combination of interactions with the operation determining circuit, the control signal output circuit, and the output control circuit, the signal process circuit is switched to a standby mode.

Accordingly, the signal process circuit can be activated based upon a volume of low-frequency current of the current signal generated in the light sensing device. Therefore, unlike conventional ways, it is not necessary to constantly pass current to the circuit to detect light during a standby mode, thereby realizing an optical receiver and an optical receiver for optical fiber link that can reduce running current during the standby mode.

Further, in the above structure, presence or absence of light is determined solely based upon a fact that light is supplied to a light sensing device that processes a signal.

Therefore, it is not necessary to additionally prepare an element for detecting light during a standby mode, that is, a photodiode for detecting an optical signal, thereby avoiding expansion of chip area in a case of OPIC (Optical IC).

Further, the following examines, as a comparison, a structure in which the control signal output circuit is not included and, for example, a duty ratio detecting circuit is directly used to generate a control signal (FIG. 18). In this case, a level of the output signal of the duty ratio detecting circuit is either a level indicating presence of incoming signal (for example, high) or a level indicating absence of signal (for example, low). When an optical burst signal stops, a wave occurs in outputs of an amplifier. As a result, an error pulse is generated in the output of the optical receiver for a certain period of time. The error pulse causes fluctuation in an output signal of the duty ratio detecting circuit. Specifically, the level repeatedly changes between high and low in a short period of time. This results in fluctuation of signal that switches on or off the output control circuit after the optical signal is switched off, making the output of the optical receiver unstable.

On the contrary, in the above structure of the present invention, a determination signal with the level changing speed described above is generated. The determination signal is compared with a boundary value TH. Either an ON signal or an OFF signal is outputted as a control signal, depending upon a result of the comparison. Then, in accordance with the control signal, outputting of an output signal of the signal process circuit is switched on or off.

In other words, instead of switching on or off the output control circuit based upon the level of the output signal (high or low) of the duty ratio detecting circuit itself, the determination signal is gradually increased or decreased in accordance with the level of the output signal of the duty ratio detecting circuit. The output control circuit is switched on or off depending upon whether the determination signal is greater than a predetermined value.

Therefore, after fluctuation of the output signal of the duty ratio detecting circuit is stabilized and a level indicating absence of signal (for example, low) has been maintained for a sufficient period of time, a control signal for switching off the output control circuit can be outputted for a first time. In other words, fluctuation of a signal that controls the output control circuit can be avoided although the output signal of the duty ratio detecting circuit is fluctuated. This can efficiently prevents instability of the output of the optical receiver even when the output signal of the duty ratio detecting circuit fluctuates.

The above structure can be divided into the following two parts.

### EXAMPLE 1

### As a Determination Signal (H1) in FIG. 5

A determination signal is generated in such a way in which a level of the determination signal is changed at a level changing speed in which: if a first change of the signal G from GB (low) to GA (high) occurs for the first time while the signal C is CA, the level is increased and, while the signal C is CA, is greater than a predetermined boundary value TH; if a second change of the signal G from GA to GB occurs after the first change, the level, while the signal C is CA, is increased when the signal G is GA or is decreased when the signal G is GB, and would not be lower than the boundary value TH while the signal C is CA; and after the signal C is changed from CA to CB after the second change, the level becomes lower than the boundary value TH. Then, the determination signal is compared to the boundary value TH. While the signal C is CA, an ON signal is outputted as a control signal if the determination signal is greater than the boundary value TH, or an OFF signal is outputted as a control signal if the determination signal is lower than the boundary value TH.

### EXAMPLE 2

### As a Determination Signal in FIG. 7

A determination signal is generated in such a way in which a level of the determination signal is changed at a level changing speed in which: if a first change of the signal G from GB (high) to GA (low) occurs for the first time while the signal C is CA, the level is decreased and, while the signal C is CA, is lower than a predetermined boundary value TH; if a second change of the signal G from GA to GB occurs after the first change, the level, while the signal C is CA, is decreased when the signal G is GA or is increased when the signal G is GB, and would not be greater than the boundary value TH while the signal C is CA; and after the signal C is changed from CA to CB after the second change, the level becomes greater than the boundary value TH. Then, the determination signal is compared to the boundary value TH. While the signal C is CA, an ON signal is outputted as a control signal if the determination signal is lower than the boundary value TH, or an OFF signal is outputted as a control signal if the determination signal is greater than the boundary value TH.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a block diagram illustrating a structure of an optical receiver in the present invention.

FIG. 2 is a diagram illustrating waveforms of photocurrent of a light sensing device.

FIG. 3 is a circuit diagram illustrating a structure of a duty ratio detecting circuit.

FIG. 4 is a circuit diagram illustrating a structure of a delay circuit.

FIG. 5 is a diagram illustrating waveforms of voltage of each signal.

FIG. 6 is a circuit diagram illustrating a structure of a duty ratio detecting circuit.

FIG. 7 is a diagram illustrating waveforms of voltage of each signal.

FIG. 8 is a block diagram illustrating a structure of an optical receiver of the present invention.

FIG. 9 is a circuit diagram illustrating a structure of a delay circuit.

FIG. 10 is a diagram illustrating waveforms of voltage of each signal.

FIG. 11 is a block diagram illustrating a structure of an optical receiver of the present invention.

FIG. 12 is a diagram illustrating waveforms of voltage of each signal.

FIG. 13 is a block diagram illustrating an optical receiver in the present invention.

FIG. 14 is a circuit diagram illustrating a structure of a time-constant-predetermined hysteresis circuit.

FIG. 15 is a circuit diagram illustrating a structure in a neighborhood of a Schmidt trigger circuit.

FIG. 16 is a diagram illustrating waveforms of voltage of each signal.

FIG. 17 is a diagram illustrating waveforms of voltage of each signal.

FIG. 18 is a block diagram illustrating a structure of an optical receiver.

FIG. 19 is a diagram illustrating time response characteristics of a second or greater order high-pass filter.

FIG. 20 is a diagram illustrating time response characteristics of a second or greater order high-pass filter upon inputting an optical burst signal.

FIG. 21 is a diagram illustrating waveforms of voltage of each signal.

FIG. 22 is a block diagram illustrating a structure of a conventional optical receiver.

FIG. 23 is a circuit diagram illustrating a structure of a conventional optical receiver.

### DESCRIPTION OF THE EMBODIMENTS

### First Embodiment

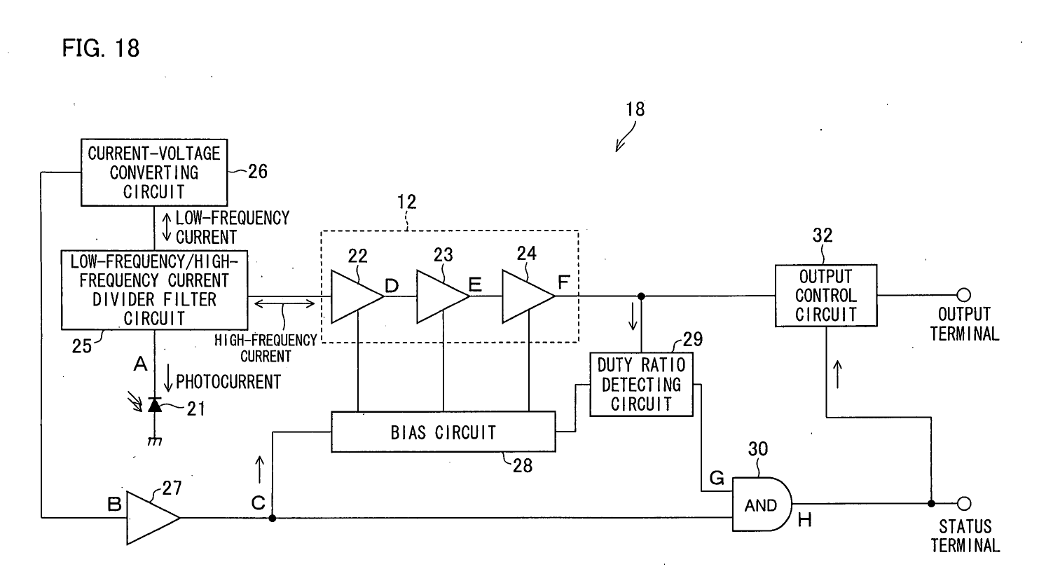

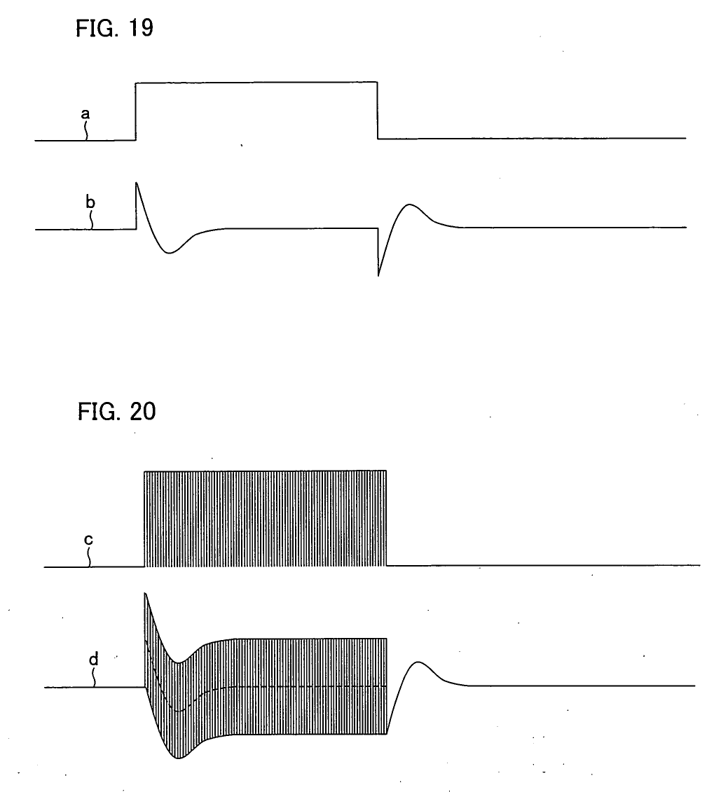

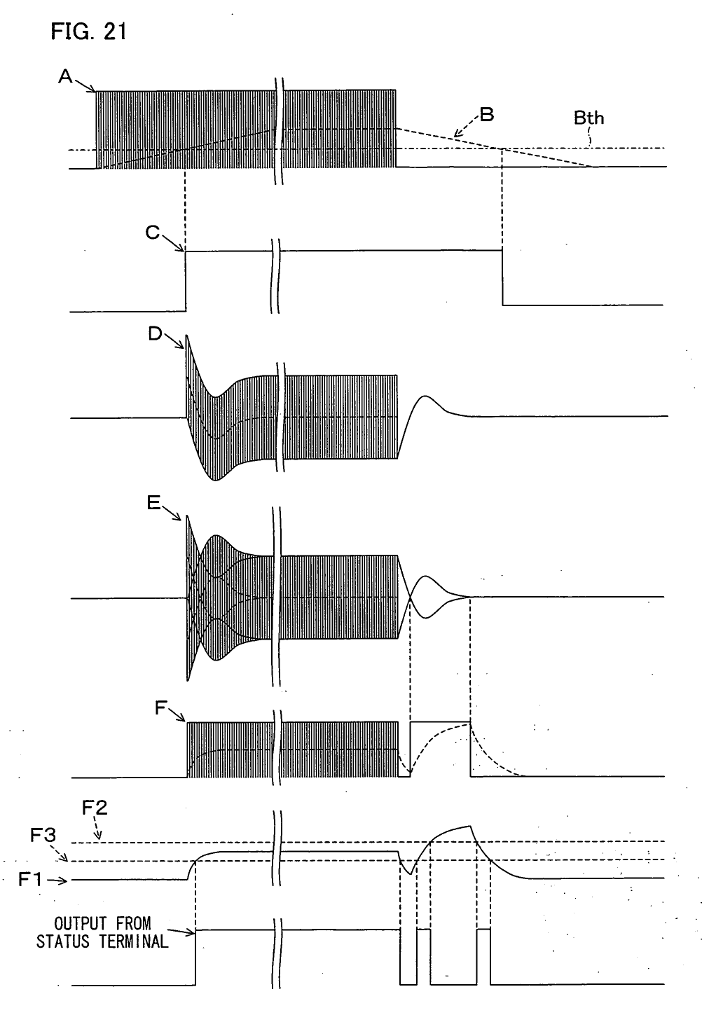

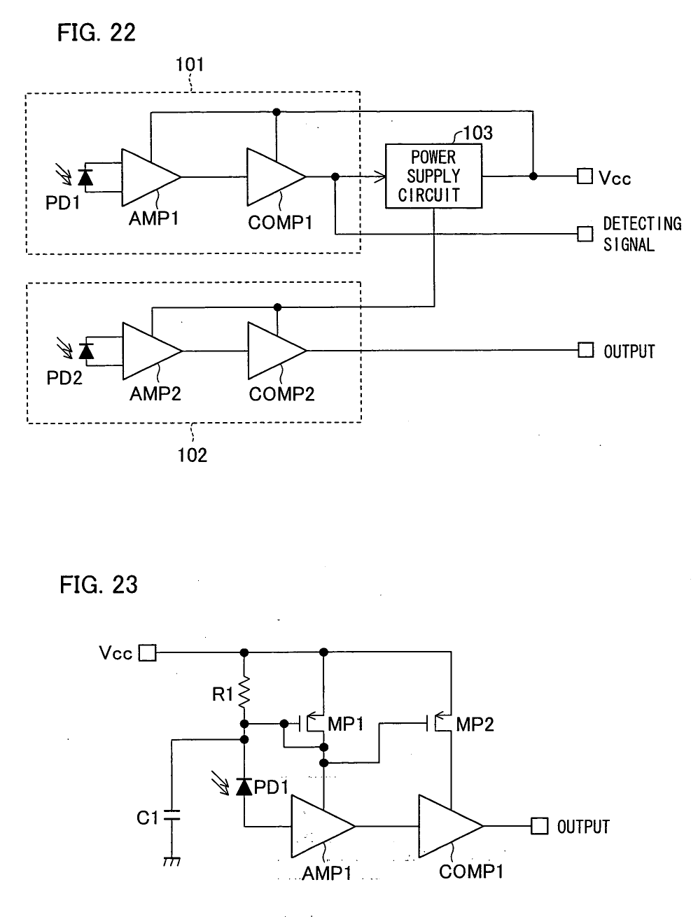

The following describes an overview by comparing to a comparative example. FIG. 18 illustrates a comparative example. In the structure, when frequency characteristics of an amplifier exhibit characteristics of a high-pass filter of second or greater order, time response characteristics of the amplifier is such that voltage of the opposite polarity is generated and then the voltage is converged to zero, as illustrated in FIG. 19. In Figure, “a” is current (photocurrent) that passes in a light sensing device when a rectangular-shaped-wave optical signal enters, and “b” is outputted voltage of the amplifier. Accordingly, if an optical burst signal is impressed to the amplifier, an average value converges zero after a certain time period. Then, when the optical burst signal stops, fluctuation occurs in outputs of the amplifier in the same manner as to when the optical burst signal starts entering, as illustrated in FIG. 20. Further, “c” is current (photocurrent) that runs the light sensing device when the optical burst signal enters, and “d” is outputted voltage of the amplifier. Consequently, an error pulse occurs for a certain time period in outputs of the optical receiver. Because of the error pulse, an output (STATUS terminal output) of a duty ratio detecting circuit 29 fluctuates, as illustrated in FIG. 21. As a result, a signal that switches on or off an output control circuit is fluctuated after the optical signal stops, and therefore the output becomes unstable. Moreover, because, for example, an interface control IC monitors a signal from the STATUS terminal of the optical receiver and switches over between an operation mode and a shut-down mode according to the signal from the STATUS terminal, operation of the interface control IC also becomes unstable if the signal from the STATUS terminal fluctuates and becomes unstable.

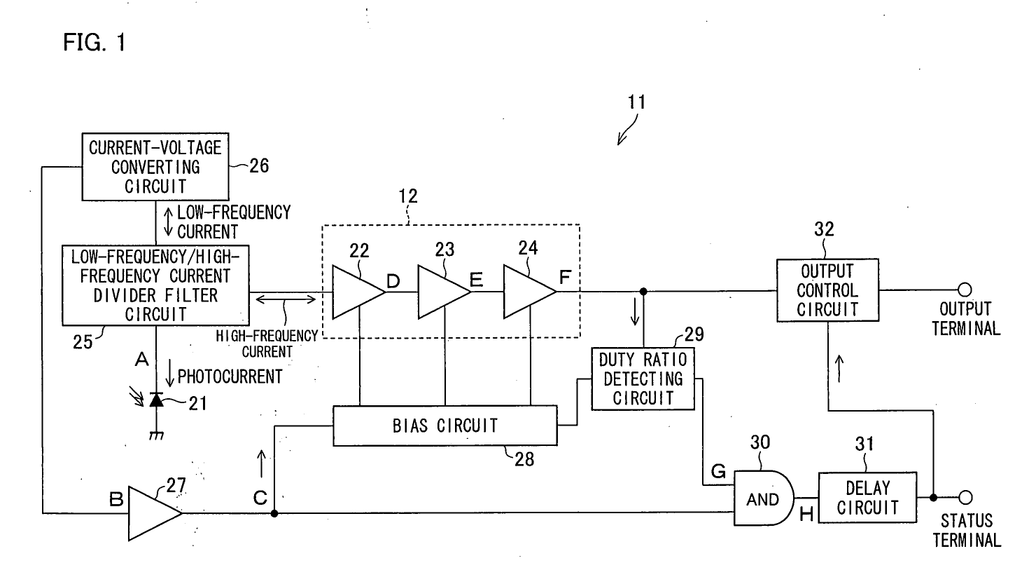

In the same manner as to the structure in FIG. 18, an optical receiver of the embodiment, for example as illustrated in FIG. 1, includes an optical signal detecting circuit that can detect a DIRECT current component of the light sensing device and can switch over a receiving circuit between the shut-down mode and the operation mode. The optical receiver of the embodiment further includes a duty ratio detecting circuit 29 that detects a duty ratio of an output and determines whether or not the signal is a modulating signal. In contrast to the structure in FIG. 18, the optical receiver of the embodiment, for example as illustrated in FIG. 1, further includes a delay circuit that delays respective outputs of the optical signal detecting circuit and the duty ratio detecting circuit 29. This prevents a signal from the STATUS terminal from fluctuating after input of an optical burst signal stops, and stabilizes the signal from the STATUS terminal.

FIG. 1 is a block diagram of an optical receiver of the embodiment of the present invention. The light sensing device 21 receives an optical signal (optical burst signal) from outside through, for example, a fiber cable. Then, the photoreceptor 21 converts the optical signal into a current signal (photocurrent). The current signal of the light sensing device 21 is divided by a low-frequency/high-frequency current divider filter circuit 25 into a low-frequency current component that is similar to the direct current element of the current signal and a high-frequency current component that contains a data sequence.

The low-frequency current component is converted from current into voltage by a current voltage converting circuit 26. Then, the converted voltage is inputted to a comparator 27. An output of the comparator 27 is inputted to a bias circuit 28 and is used to activate a signal process circuit 12.

The high-frequency current component is inputted to the signal process circuit 12 which converts the high-frequency current component into a signal. The signal is outputted from the signal process circuit 12 via the output terminal under control of an output control circuit 32. The signal outputted from the signal process circuit 12 is also inputted to a duty ratio detecting circuit (operation determining circuit) 29. An output of the duty ratio detecting circuit 29 and an output of a comparator 27 are supplied to an AND circuit 30, and an output from the AND circuit 30 is inputted to the delay circuit 31. Finally, the delay circuit 31 outputs a signal that controls switching on and off of the output control circuit 32 so as to control outputs therefrom.

The signal process circuit 12 is formed with a first-stage amplifier 22, a second amplifier 23, and a comparator 24. The optical signal detecting circuit is formed with the low-frequency/high-frequency current divider filter circuit 25, the current voltage converting circuit 26, and the comparator 27. An activation control circuit is formed with the low-frequency/high-frequency current divider filter circuit 25, the current voltage converting circuit 26, the comparator 27, and the bias circuit 28. A control signal output circuit is formed with the AND circuit 30 and the delay circuit 31.

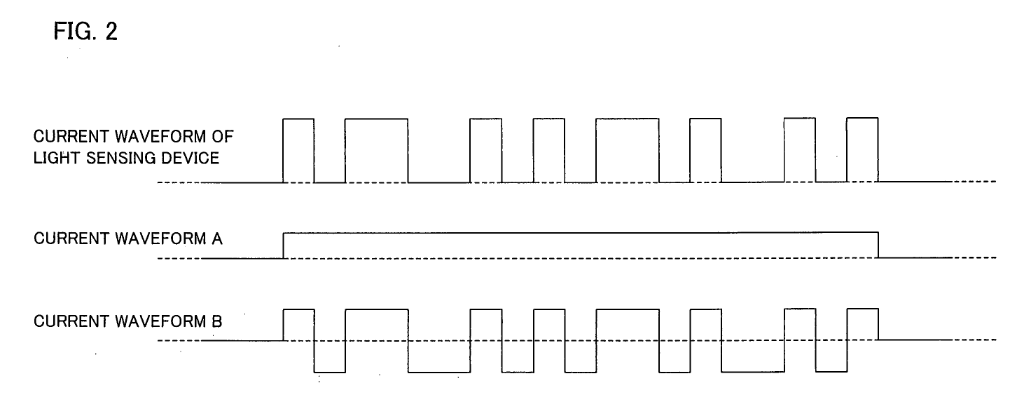

The following describes a current component of the light sensing device 21, with reference to FIG. 2. The waveform of current of the light sensing device that is illustrated in FIG. 2 is a waveform exhibited when the light sensing device 21 receives an optical signal which has been subjected to bi-phase mark modulation (the waveform in FIG. 2 is a waveform in a case where the data sequence is “1001101011”). The optical signal is used in optical fiber links of digital audio or in-vehicle MOST. It is apparent that the waveform of current of the light sensing device 21 is a sum of a current waveform A and a current waveform B. The current waveform A is a low-frequency current component and becomes a direct current component in a case where a data sequence is sufficiently long. The current waveform B is a high-frequency current component and is a signal containing information on data sequence. Low-frequency current that corresponds to the current waveform A is converted into voltage by the current voltage converting circuit 26. When the voltage exceeds a certain level, an output of the comparator 27 is reversed, and a mode of the bias circuit 28 is switched from a standby mode to an operation mode, so that the first-stage amplifier 22, the second-stage amplifier 23, the comparator 24, and the duty ratio detecting circuit 29 are supplied with bias current, and the signal process circuit 12 starts operating. On the other hand, high-frequency current containing a data sequence is converted from current into voltage by the first-stage amplifier 22 and is amplified by the second-stage amplifier 23. Then, the waveform of the amplified voltage is shaped by the comparator 24.

The duty ratio detecting circuit 29 and the output control circuit 32 are connected to an output terminal of the comparator 24. The duty ratio detecting circuit 29 determines whether a duty ratio of an output signal of the comparator 24 is within a predetermined range. When a bi-phase signal whose duty ratio is approximately 50%, such as a modulation signal of digital audio or MOST, is inputted, an output of the duty ratio detecting circuit 29 becomes high level. When an output of the comparator 27, which is an output of the optical signal detecting circuit, is high level (in other words, when an optical signal is inputted), an output of the STATUS terminal becomes high level. In this case, the output control circuit 32 lets an output signal of the comparator 24 go through so that a signal is outputted to the output terminal.

When an optical signal whose duty ratio is out of a preset range of the duty ratio detecting circuit 29 and which optical signal is not an expected modulation signal, such as direct current light, is inputted, an output of the duty ratio detecting circuit 29 becomes low level. Because a direct current component of light is detected, an output of the comparator 27, which is an output of the optical signal detecting circuit, becomes high level. An output of the STATUS terminal is a product of an output of the comparator 27 and an output of the duty ratio detecting circuit 29, and therefore becomes low level. As a result, the output control circuit 32 shields an output signal of the comparator 24, and the output terminal is fixed either at high level or at low level.

In this configuration, the delay circuit 31 using a low-pass filter is disposed across the AND circuit 30 and the STATUS terminal, thereby effectively removing and suppressing fluctuation in an output of the STATUS terminal which is generated after inputting of an optical burst signal is stopped and which contains a short pulse caused by an amplifier having high-pass filter characteristics of second or greater order.

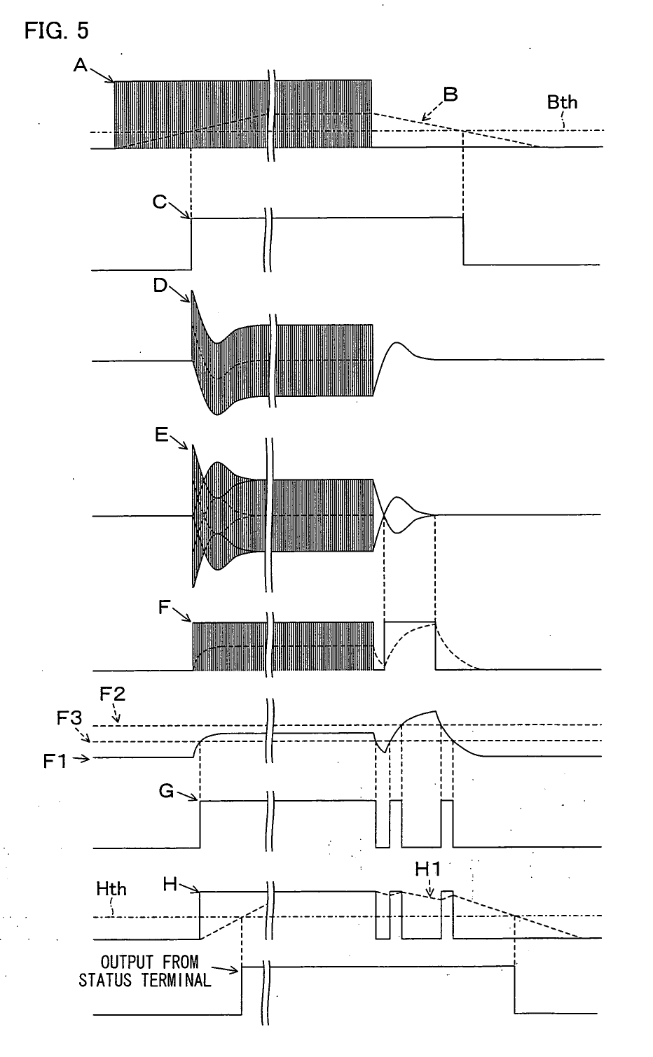

The following describes waveforms of each section in detail. FIG. 5 illustrates waveforms of each section exhibited when an optical burst signal (signal with a duty ratio of 50%) enters the light sensing device 21. “A” is current running the light sensing device 21 when an optical burst signal enters. The current running the light sensing device 21 is divided into a low-frequency current component and a high-frequency current component by the low-frequency/high-frequency current divider filter circuit 25. The low-frequency current component is used for detecting an optical signal and is converted into voltage by the current voltage converting circuit 26. A waveform of the converted voltage has a shape of a waveform B. When the waveform B exceeds a threshold value of the comparator 27, an output of the comparator 27 is changed from a low level to a high level, as shown in a waveform C. The bias circuit 28 is activated, and the first-stage amplifier 22, the second-stage amplifier 23, the comparator 24, and the duty ratio detecting circuit 29 are supplied with bias current. Consequently, the signal process circuit 12 is activated. When the signal process circuit 12 is activated, a high-frequency component of the photocurrent running the light sensing device 21 is amplified by the first-stage amplifier 22, and is shaped as shown in a waveform D. Note that the figure illustrates a case where the first-stage amplifier 22 and the second-stage amplifier 23 are coupled by a shared capacitor, and second high-pass filter characteristics are exhibited in combination with the first stage low-frequency/high-frequency current divider filter circuit 25. Further, the waveform D is amplified by the second-stage amplifier 23 and becomes as shown in a differential output waveform E. Then, the waveform is shaped by the comparator 24, and a waveform F is outputted.

As described above, after the optical burst signal stops, an error pulse is generated due to the second order high-pass filter characteristics. An output of the comparator 24 is inputted to the duty ratio detecting circuit 29 and the output control circuit 32 that controls whether or not to pass an output waveform of the comparator 24 therethrough to the output terminal.

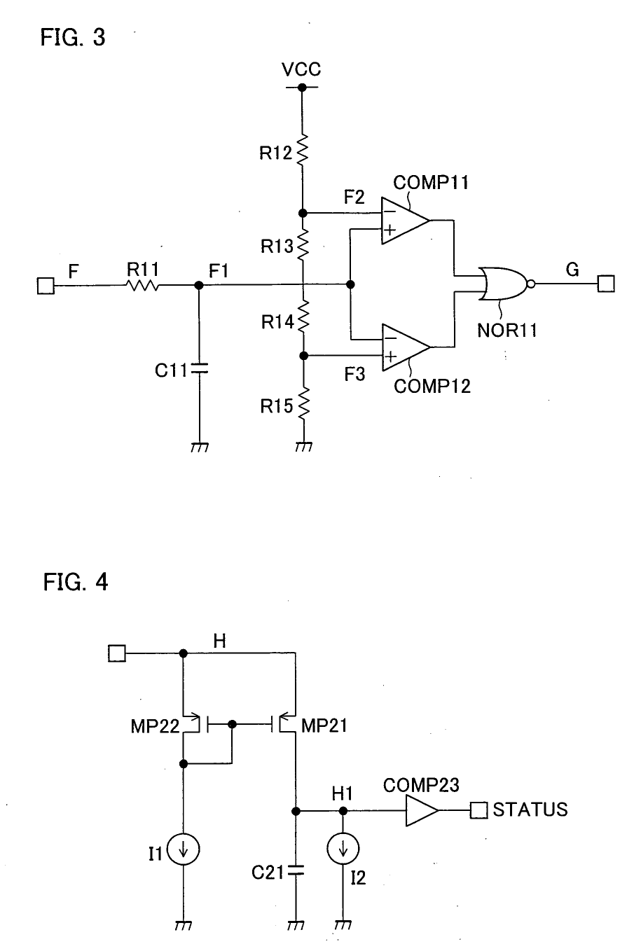

FIG. 3 illustrates an example of the duty ratio detecting circuit 29. Based upon the waveform F outputted from the comparator 24, an average level (waveform F1) of the waveform F is outputted with a low-pass filter formed with R-11 and C-11. By a window comparator formed with a COMP (comparator)-11, COMP-12, and NOR-11, an output G becomes high level when a level of F1 is between F2 and F3, or becomes low level when the level of F1 is not between F2 and F3. Therefore, by discretionary setting levels of F2 and F3, a duty ratio of the waveform F can be detected.

At this point, due to an error pulse of the waveform F that is generated after the optical burst signal stops, an output of the duty ratio detecting circuit 29 fluctuates as shown in the waveform G. In order to prevent the fluctuation, a logical product of the output of the duty ratio detecting circuit 29 and the output of the optical signal detecting circuit (output of comparator 27) is obtained through the AND circuit 30 (FIG. 1), and the logical product is inputted to the delay circuit 31. When the output H of the AND circuit 30 is changed from low level to high level, a constant current I1 runs across C-21, and an electric potential V of H1 increases in accordance with the formula below:
(dV/dt)=I1/N/C21 (1).
In the above formula, “t” is time, and the ratio of gate ranges of MP-21 and MP-22 is (1:N).

On the other hand, when the output H of the AND circuit 30 is changed from high level to low level, no constant current I1 runs across C-21, and constant current I2 runs across C-21. The electric potential V of H1 decreases in accordance with the following formula:
(dV/dt)=I2/(−N)/C21 (2).

When a voltage of H is high, the relationship set forth in the following formula is satisfied:
(dV/dt)=A/kh.
In the above formula, “kh” is a time constant (unit: second, kh>0) of the delay circuit 31 when the voltage of H is high, and “A” is a positive constant (unit: V).

When the voltage of H is low, the relationship set forth in the following formula is satisfied:
(dV/dt)=−B/kl.
In the above formula, “kl” is a time constant of the delay circuit 31 when the voltage of H is low, and “B” is a positive constant (unit: V).

When the electric potential of H1 exceeds a threshold value (Hth) (boundary value TH), the output from the STATUS terminal is reversed. A constant current source I1 is a current-charging source, and a constant current source I2 is a current-discharging source.

Here, the time constant of the delay circuit 31 is set in such a way that the time constant is sufficiently long so that an output of COMP-23 will not be reversed due to fluctuation in the waveform G of the output of the duty ratio detecting circuit 29, thereby preventing fluctuation in an output of the STATUS terminal due to error pulses generated by the second high-pass filter.

In other words, if the time constant k is set at a sufficiently high value, even when the voltage of H temporarily becomes low due to fluctuation of G and the electric potential V of H1 starts decreasing, such temporal time period of low voltage would not cause V to be tremendously decreased, causing no situation in which the electric potential V drops below the threshold value of COMP-23. Therefore, an output of the STATUS terminal does not fluctuate. On the other hand, when fluctuation of G stops and the condition changes to a condition where the voltage of H becomes constantly low, the electric potential V of H1 continues to decrease in accordance with the above formula. Eventually, the electric potential V drops below the threshold value of COMP-23, and the output of the STATUS terminal is reversed. Therefore, the output from the output terminal can be intentionally made to be OFF.

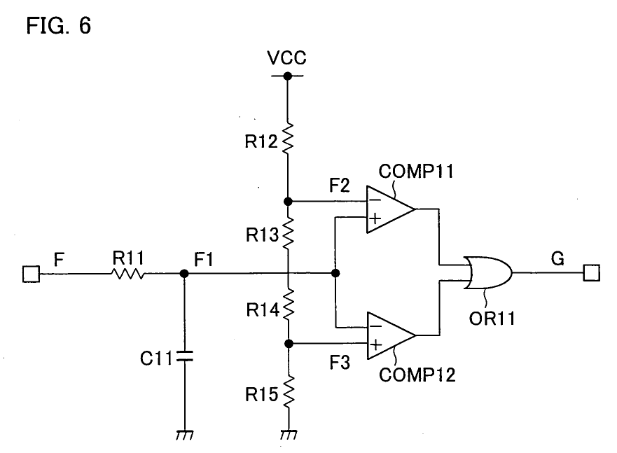

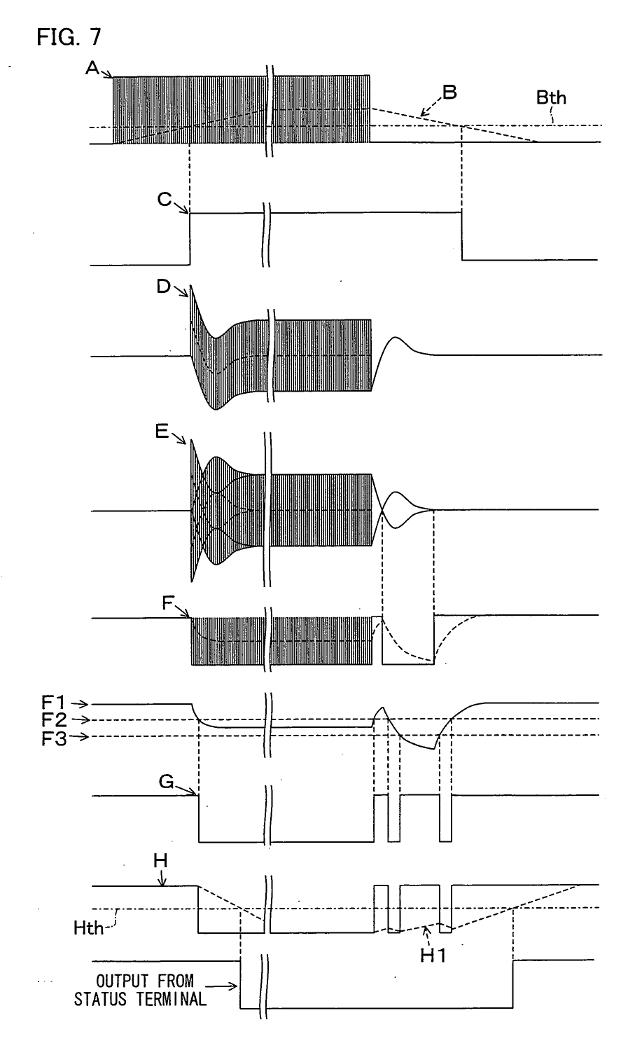

FIG. 7 illustrates waveforms having structures in which all directions of changes in voltage of F, F1, F2, F3, G, H, and H1 in FIG. 5 are reversed. In this case, the logic of the window comparator is reversed. Therefore, a circuit of the window comparator needs to have an OR-11, as illustrated in FIG. 6, in place of the NOR-11 in FIG. 3. The delay circuit can be remained the same as illustrated in FIG. 4.

### Second Embodiment

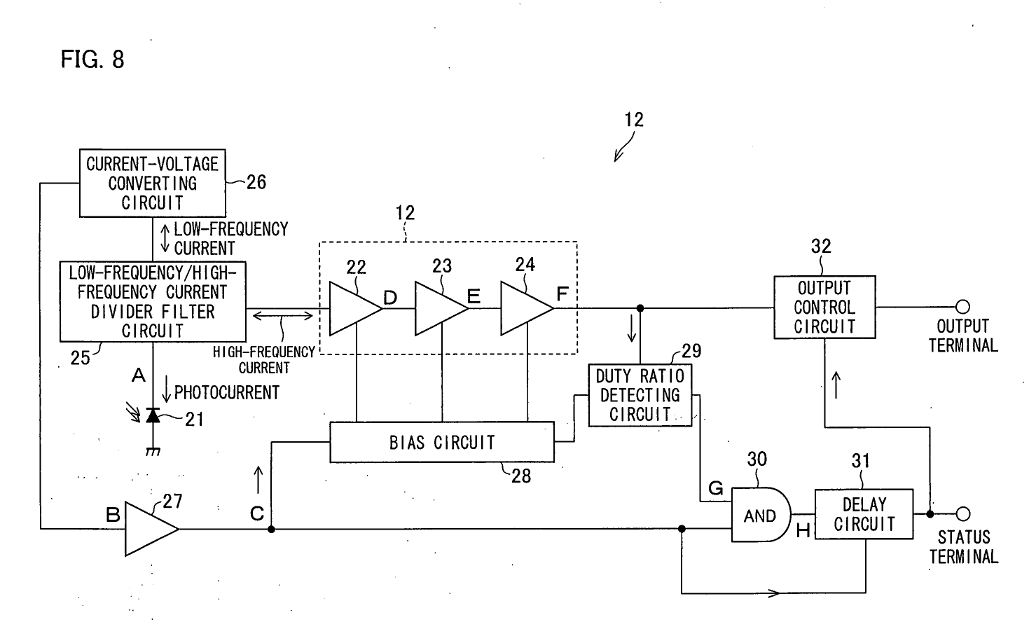

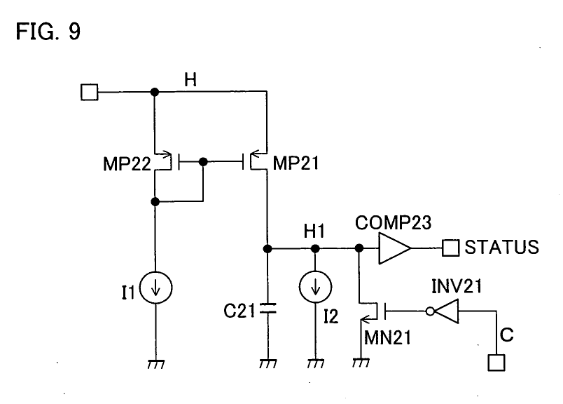

FIG. 8 illustrates a Second Embodiment of the present invention. As illustrated in FIG. 9, an N-channel MOS transistor MN-21 and an inverter INV-21 are added to the delay circuit 31 disposed across the AND circuit 30 and the STATUS terminal in the First Embodiment. Further, an output terminal of the comparator 27 is connected to an input terminal of INV-21. When the output of INV 21 is changed from low level to high level (output of the signal detecting circuit is changed from a signal-present status to a signal-absent status), the electric potential of H1 is connected to GND by MN-21 so as to be low level. This changes the output of the STATUS terminal from high level to low level.

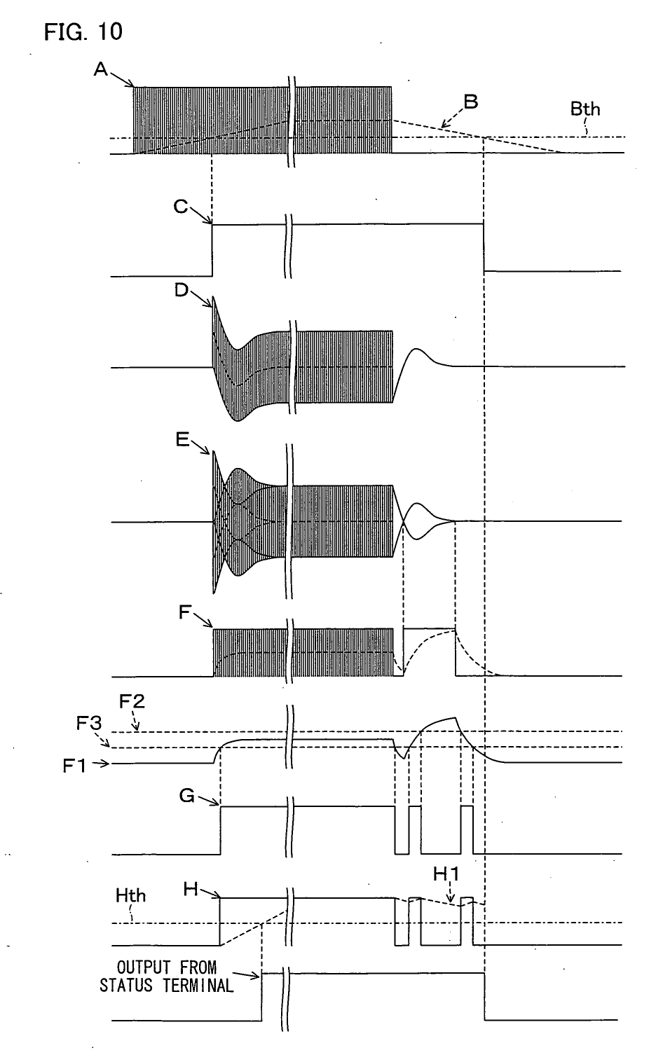

As illustrated in FIG. 10, the time period in which the output of the STATUS terminal is changed from high level to low level after the optical burst signal stops can be made shorter than that of in the First Embodiment in FIG. 5, thereby achieving a prompt shut-down.

Further, the delay circuit in FIG. 9 is operable without discharging current I2. When I2 is zero, the electric potential of H1 is held while the output G of the duty ratio detecting circuit 29 is low level. When the electric potential of H1 is high level, H is fixed at a high level. At the timing when C, which is an output of the signal detecting circuit, drops, the output of the STATUS terminal becomes a shut-down mode.

### Third Embodiment

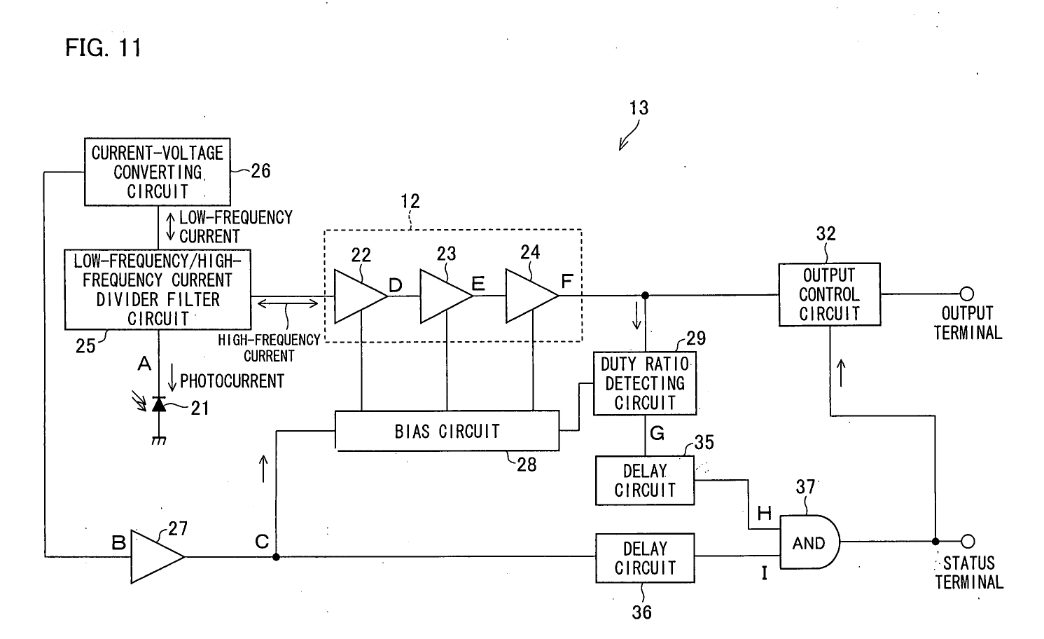

FIG. 11 illustrates a Third Embodiment of the present invention. The Third Embodiment is different from the First Embodiment in that a delay circuit (control signal output circuit) 35 is disposed to be connected with an output terminal of a duty ratio detecting circuit 29, and a delay circuit (control signal output circuit) 36 is disposed to be connected with an output terminal of the comparator 27. Outputs from both the delay circuits are supplied to the AND circuit (control signal output circuit) 37. A logical product of the outputs through the AND circuit 37 is inputted to the output control circuit 32.

Structures of the delay circuits 35 and 36 are basically the same as that of the delay circuit 31 in the First Embodiment. By appropriately changing a capacitance or a resistance of elements in the circuit, the threshold value (the threshold value corresponds to Hth in the First Embodiment) or the time constant can be arbitrarily set. In the delay circuit 36, a determination signal (second determination signal) C1 and a threshold value Cth that correspond to the determination signal H1 and the threshold value Hth, respectively, of the delay circuit 35 or the delay circuit 31 of the First Embodiment are set in advance. By setting the time constant of the delay circuit 35 longer than the time constant of the delay circuit 36, as described below, fluctuation generated in an output of the STATUS terminal after the optical burst signal stops can be prevented.

The optical signal is inputted, and the output of the comparator 27 is changed from low level to high level, and then the bias circuit 28 is activated. However, it requires a certain period of time for the bias circuit 28 to be in a stationary state. Moreover, upon activation of the first-stage amplifier 22, current may run in a direction toward the optical signal detecting circuit, causing fluctuation in the output of the comparator 27. Therefore, the delay circuit 36 is disposed.

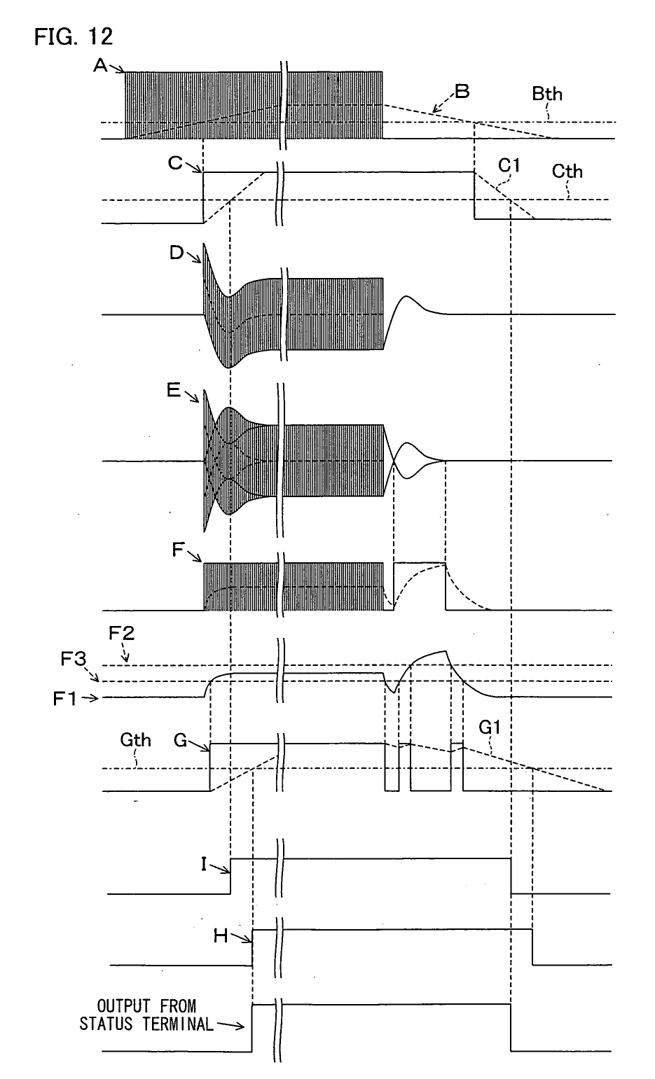

FIG. 12 illustrates waveforms of the nodes (A-H) in FIG. 11. “Cth” is the threshold value in the delay circuit 36 that is the same as the threshold value explained with respect to the delay circuit 31 of the First Embodiment. The output G of the duty ratio detecting circuit 29 goes through the delay circuit 35 having a sufficiently long time constant. As a result, fluctuation is suppressed, and the waveform becomes as a waveform H. Further, the output of the comparator 27 goes through the delay circuit 36 and becomes as a waveform I. A logical product of I and H is obtained through the AND 37 and is outputted to the STATUS terminal.

In this configuration, when the time constant of the delay circuit 35 is smaller than the time constant of the delay circuit 36, fluctuation in the waveform H of the output of the delay circuit 35 that is caused by the fluctuation in the waveform G of the output of the duty ratio detecting circuit 29 cannot be prevented. Consequently, the output of the STATUS terminal is also fluctuated. Therefore, the time constant of the delay circuit 35 is sufficiently longer than that of the delay circuit 36.

In the configuration, a receiver (optical receiver) for optical fiber includes an optical signal detecting circuit and a duty ratio detecting circuit 29 that detects a duty ratio of an output, and if the level of the optical signal exceeds a predetermined value, and if the duty ratio of an optical signal is within a predetermined range, the optical receiver that outputs via the STATUS terminal or the output terminal. In the configuration, as described above, the time constant of the duty ratio detecting circuit 29 is set longer than that of the optical signal detecting circuit, thereby preventing errors in operations of the STATUS terminal.

### Fourth Embodiment

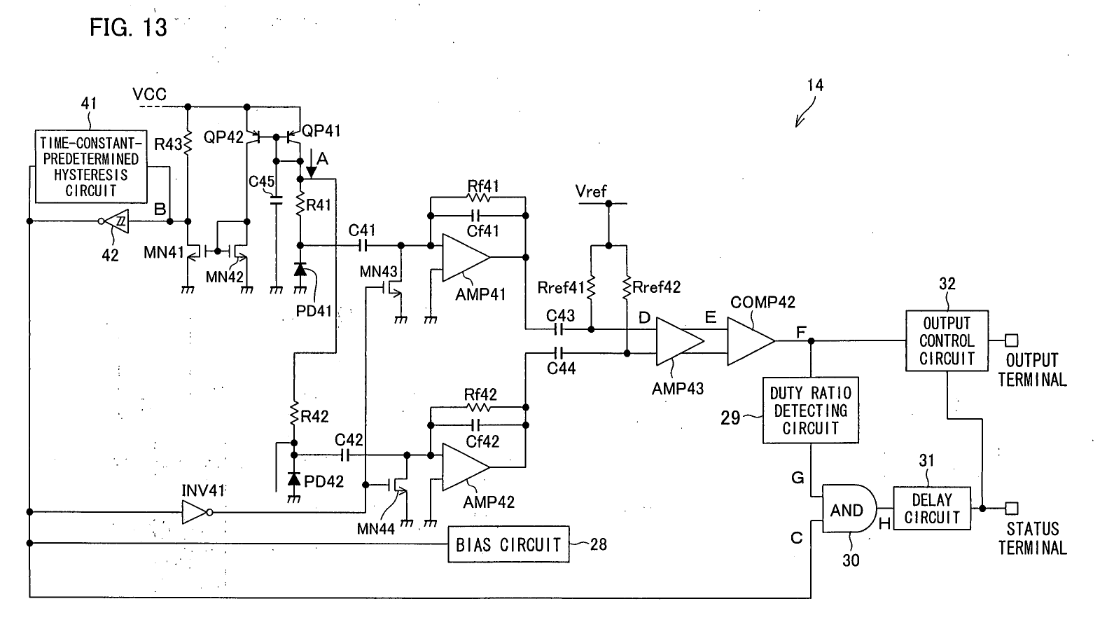

FIG. 13 illustrates a structure in the Fourth Embodiment. Among the elements described below, common components to the First to Third Embodiments described above (for example, PD-41, C-41, AMP-41, Rref-41 . . . ) can be used in the First to Third Embodiments, unless otherwise indicated. In the First to Third Embodiments, common components to the Fourth Embodiment may have the same circuit structure as illustrated in FIG. 13.

A modulated optical signal is converted into a current signal by the light sensing device PD-41. When the light receiving device is in a standby mode, a gate voltage of an N-type channel MOSFET (MN-43) is high level. When MN-43 is ON, one of the electrodes of the capacitor C-41 is grounded to GND level. When the resistor R-41 and MN-43 are ON, a low-frequency current component of electric current running the light sensing device PD-41 is passed to the resistor R-41 and a high-frequency current component thereof is passed to the capacitor C-41 by means of a filter circuit formed with the grounded capacitor C-41. The current running through the resistor R-41 becomes a current signal that has gone through a low-pass filter having cut-off frequency of:
fc=1/{2π(R41+Vt/IDC_{—}PD)C41}
(Vt: k·T/q
k: Boltzmann's constant
T: absolute temperature
q: elementary charge
IDC_PD: direct current component running the light sensing device PD-41).
   On the other hand, the current running the capacitor C-41 becomes a current signal that goes through a high-pass filter having the cut-off frequency of fc described above. A bi-phase mark modulated signal that is popularly used in optical fiber links for digital audio or MOST-standard optical fiber communications of in-vehicle fiber is maintained at a duty ratio of 50%. Therefore, the signal is divided into a direct current component and an alternating current component (for 25 Mbps bi-phase signal, alternating current components of 50 MHz and 25 MHz) by the low-frequency/high-frequency current divider filter circuit.

By a current mirror constituted of PNP transistor QP-41 and QP-42, a current is run in an opposite direction with respect to the direct current running through the resistor R-41. Accordingly, a current is run in an opposite direction with respect to a current mirrored by a current mirror constituted of PNP transistors QP-41 and QP-42. This current is voltage-converted by the resistor R-43.

A bias voltage VR of the light sensing device PD-41 may be set at a high value as (Vcc−Vbe) (for example, when Vcc=5V and Vbe of QP-41=0.6V, VR is calculated as VR=4.4V) when entering light is weak (when a voltage generated by R-41 is low). Therefore, when the light sensing device is a photodiode, a parasitic capacitance becomes low. This facilitates optical receivers speeding up and reducing noise in optical receivers. “Vbe” is a voltage between base and emitter.

An area ratio of emitters of QP-41 and QP-42 is set to be 1:N, or a width ratio of gates of MN-41 and MN-42 is set to be 1:N. By doing so, current may be amplified to N times greater by the current mirror.

When voltages at both ends of the Resistor R-43 exceed a threshold value of a Schmidt trigger circuit (SCHMITT) 42, an output of the Schmidt trigger circuit 42 is changed from low level to high level, and the bias circuit 28 is activated. When the bias circuit 28 is activated, AMP-41, AMP-42, AMP-43, and CMP-43 all of which constitute the signal process circuit 12, and the duty ratio detecting circuit 29 are provided with bias current, and the signal process circuit 12 is activated. Further, as the gate voltage of the N-type channel MOSFET (MN-43) becomes low level, MN-43 becomes OFF. As a result, an alternating current component including a modulation signal that runs the capacitor C-41 is inputted to a current-voltage converting amplifier formed with AMP-41, Rf-41, and Cf-41.

Further, when AMP-41 is activated, an input impedance of the current-voltage converting amplifier becomes low. Therefore, even though MN-3 is off, the capacitor C-41 is connected to the ground. Thus, a filter circuit formed with the resistor R-41 and the capacitor C-41 may be made such that, between a standby mode and an operation mode, there is no significant difference in characteristics such as cut-off frequency.

Further, a light sensing device PD-42 is a dummy light sensing device having the same area as that of the light sensing device PD-41. Shielding PD-42 with a cathode electrode of PD-42 effectively reduces common-mode noise of electromagnetic noise or power line noise. In order to realize this effect, a circuit connected to PD-41 and a circuit connected to PD-42 need to have a same structure. Elements R-42, C-42, Rf-42, Cf-42, MN-44, and AMP-42 correspond to elements R-41, C-41, Rf-41, Cf-41, MN-43, and AMP-41, respectively. The circuits are perfectly symmetric.

Further, a capacitor C-45 is connected across the GND and a base and a collector of the diode-connected QP-41, so that QP-41 and C-45 constitute a low-pass filter, thereby reducing power line noise. A cut-off frequency of the low-pass filter formed with QP-41 and C-45 is:
fc=1/{2π(Vt/IDC_{—}PD)C45}
(Vt: k·T/q
k: Boltzmann's constant
T: absolute temperature
q: elementary charge
IDC_PD: direct current component that runs the light sensing device PD-41).
   Therefore, when IDC_PD is small, that is, the optical signal is weak, the impedance of QP-41 becomes high, thereby effectively reducing power line noise. When the optical signal is strong, the impedance of QP-1 becomes low, and influence of the power supply line noise is enhanced. However, an intensity of the optical signal is increased. Therefore, relative effect remains unchanged.

A unit having the same constants (R-42=R-41, C-42=C-41, MN-44=MN-43, AMP-42=AMP-41, Rf-42=Rf-41, Cf-42=Cf-41) as that of a unit connected to the light sensing device PD-41 is connected to the dummy light sensing device PD-42, so that an optical receiver that is strong to power line noise or disturbance noise can be realized.

The signal converted into voltage by AMP-41 is inputted to AMP-43 via the capacitor C-43. One end of the resistor Rref-41 is connected to a constant-voltage power supply Vref, and the other end thereof is connected to an input terminal of AMP-43. In the same manner, one of the resistor Rref-42 is connected to the constant-voltage power supply Vref, and the other end thereof is connected to the input terminal of AMP-43. The resistors determine an operating point of an input of AMP-43. A signal inputted to AMP-43 is amplified by AMP-43, and COMP-42 shapes the waveform of the amplified signal. The duty ratio detecting circuit 29 and the output control circuit 32 are connected to an output terminal of COMP-42. In the same manner as to the First Embodiment, a logical product of C, which is an output of the optical signal detecting circuit, and G, which is an output signal of the duty ratio detecting circuit 29, is obtained through the AND circuit 30. Then, ON-OFF control of the output control circuit 32 is carried out with the control signal outputted by the delay circuit 31, thereby preventing fluctuation in an output of the STATUS terminal.

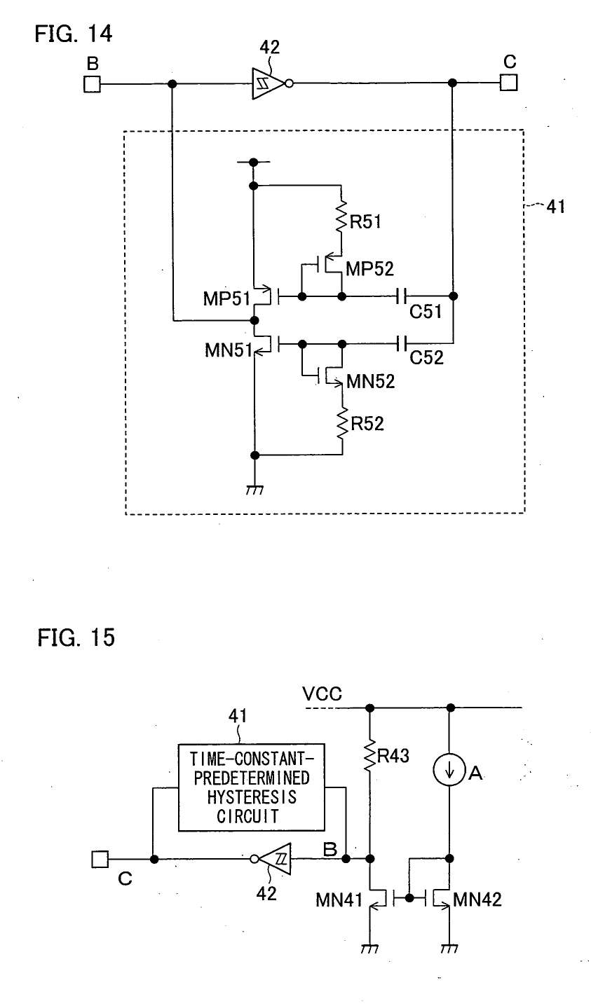

Further, when input of the optical signal stops, an output of the Schmidt trigger circuit 42 is changed from high level to low level, gates of MN-43 and MN-44 become high level, and input terminals of AMP-41 and AMP-42 are connected to a GND line. At this time, electric current is supplied to QP-41 via C-41 and C-42, and therefore the optical signal detecting circuit is activated, and voltage is instantaneously impressed across R-43. In order to prevent activation of the bias circuit caused by the voltage, a time-constant-predetermined hysteresis circuit 41 illustrated in FIG. 14 may be connected to the Schmidt trigger circuit 42, thereby preventing the optical signal detecting circuit from being instable. The time-constant-predetermined hysteresis circuit 41 is connected across that section in the activation control circuit which determines which one of the signal CA or the signal CB is outputted as the signal C. The time-constant-predetermined hysteresis circuit 41 is for hysteresis for which a time constant is predetermined.

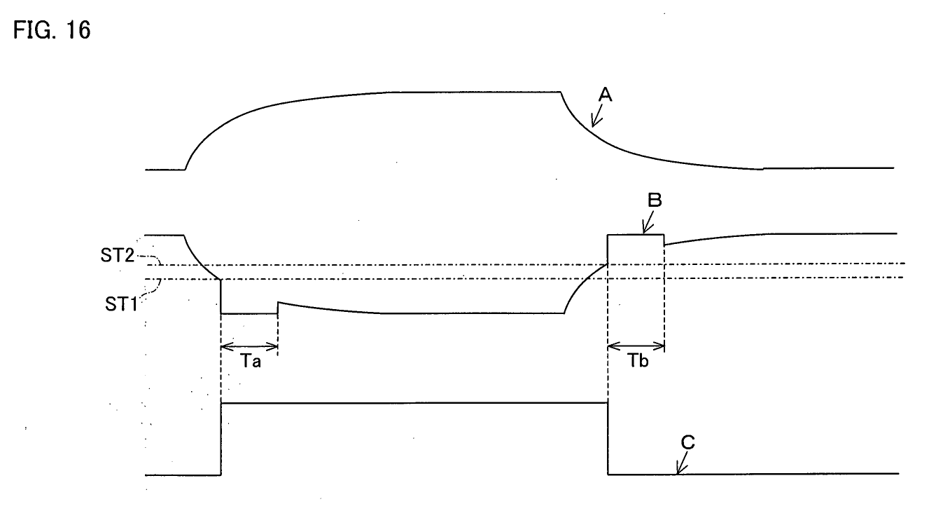

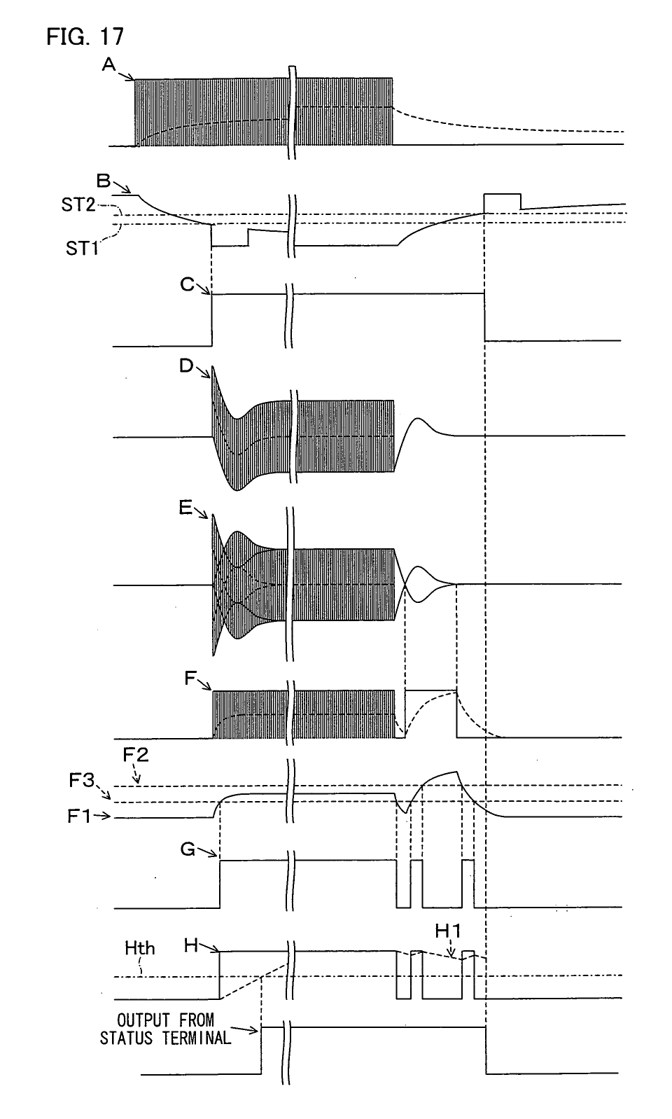

FIG. 17 illustrates waveforms of the nodes (A to H) in FIG. 13. A combination of the time-constant-predetermined hysteresis circuit 41 and the Schmidt trigger circuit 42 prevents error operation of the optical signal detecting circuit. The following describes operation of the Schmidt trigger circuit 42. In the circuit structure illustrated in FIG. 15, a direction of current of a current power supply, which is illustrated as the waveform of A in FIG. 16, is reversed by a current mirror formed with MN-42 and MN-41. Then, the current is converted into voltage by R-43. At this time, if voltages of both ends of R-43 exceed a threshold value of the Schmidt trigger circuit 42, an output of the Schmidt trigger circuit 42 is changed from low level to high level.

Here, differential current runs via C-51 and C-52 of the time-constant-predetermined hysteresis circuit 41 in FIG. 14. This causes MN-51 to be ON for a certain time period Ta and the output level of the Schmidt trigger circuit 42 to be fixed at low level. Therefore, the certain time period Ta becomes dead time, preventing error operation. In addition, as a signal level of A becomes lower, the output of the Schmidt trigger circuit 42 is changed from high level to low level. Here, differential current also runs via C-51 and C-52 of the time-constant-predetermined hysteresis circuit 41, causing MN-51 to be ON for a certain time period Tb and fixing the output level of the Schmidt trigger circuit 42 at high level. Therefore, the certain time period Tb becomes dead time, preventing error operation.

As described above, in an optical receiver that includes an optical signal detecting circuit and an output duty ratio detecting circuit in an optical fiber receptor and, when a level of the optical signal exceeds a predetermined value and a duty ratio of an optical signal is within a predetermined range, outputs via the STATUS terminal or the output terminal, by adding a time-constant-predetermined hysteresis circuit 41 to a circuit that compares levels of optical signals in the optical signal detecting circuit, thereby stabilizing a circuit that shuts down the output.

The present invention is not limited to the description of the embodiments above, but may be altered by a skilled person within the scope of the claims. An embodiment based on a proper combination of technical means disclosed in different embodiments is encompassed in the technical scope of the present invention.

Further, an optical receiver of the present invention may be structured in such a way as to include a delay circuit that delays an output from an optical signal detecting circuit and an output from a duty ratio detecting circuit.

Further, an optical receiver of the present invention may be structured in such a way that, in the above structure, the delay circuit is disposed across the STATUS terminal and the AND circuit.

Further, an optical receiver of the present invention may be structured in such a way that, in the above structure, the delay circuit is disposed across the STATUS terminal and the AND circuit, the delay circuit is formed with a constant-current charging circuit, a constant-current discharging circuit, and a capacitor, and integration electric potential is rapidly discharged at a timing when the optical signal detecting circuit is off (FIG. 9).

Further, an optical receiver of the present invention may be structured in such a way that, in the above structure, a first delay circuit is disposed across the duty ratio detecting circuit and the AND circuit, and a second delay circuit is disposed across the optical signal detecting circuit and the AND circuit (FIG. 11).

Further, an optical receiver of the present invention may be structured in such a way that, in the above structure, a time constant of the first delay circuit (delay circuit 35) is set (sufficiently) so as to be longer than that of the second delay circuit (delay circuit 36).

Further, an optical receiver of the present invention may be structured in such a way that, in the above structure, an optical signal detecting signal is returned to a switching element (MN-43) disposed across an input terminal of a first-stage current-voltage converting amplifier (AMP-41) and GND (FIG. 13).

Further, an optical receiver of the present invention may be structured in such a way that, in an optical receiver including an optical signal detecting circuit and a differentiation circuit and having a switching element in the differentiation circuit, a time-constant-predetermined hysteresis circuit is provided in the optical signal detecting circuit (FIG. 13).

The optical signal detecting circuit may be formed with PD-41, R-41, QP-41, QP-42, C-45, MN-41, MN-42, R-43, SCHMITT 41, and the time-constant-predetermined hysteresis circuit 41. The differentiation circuit (having a high-pass filter characteristic) can be structured with C-41 and R-41. Photocurrent is differentiated by the differentiation circuit, and only a high-frequency component is inputted to AMP-41. The switching element may be formed with a switching circuit formed with MN-43.

Further, an optical receiver of the present embodiment may be structured in such a way that, in the above structure, a collector of a diode-connected PNP transistor (QP-41) may be connected to a cathode of a photodiode (PD-41) via a resistor (R-41), and a power supply may be connected to an emitter of the diode-connected PNP transistor (QP-41). Further, one end of a capacitor (C-45) may be connected both to a base and a collector of the diode-connected PNP transistor (QP-41), and the other end of the capacitor (C-45) may be connected to GND. Further, a dummy photodiode (PD-42) may be connected to the base and the collector of the diode-connected PNP transistor (QP-41) via a resistor (R-42).

Further, an optical receiver of the embodiment may be structured in such a way that, in the above structure, an output from the STATUS terminal functions as a control signal of the output control circuit.

Further, an optical receiver of the present embodiment may be structured in such that an optical receiver for optical fiber link that employs an optical receiver structured in any one of the ways described above is formed.

Further, a control signal output circuit of an optical receiver of the embodiment, after the second change, and even after the signal C changes from CA to CB, the control signal output circuit changes the level of the determination signal at the same level change rate that the level of the determination signal is changed at least beyond the boundary value TH within the period in which the signal C is CA.

In the above structure, even after the signal C is changed from CA to CB, the level of the determination signal is changed at the same level changing speed as that of when the signal C is CA, and reaches a level that passed the boundary value TH. Therefore, fluctuation in the control signal can be suppressed without any additional structures, thereby simplifying the structure, in addition to the advantages of the above structure.

Further, a control signal output circuit of an optical receiver of the embodiment, after the second change, the control signal output circuit changes, at a timing when the signal C is changed from CA to CB, the level of the determination signal to be beyond the boundary value TH.

In the above structure, after the second change, the determination signal passes the boundary value TH at a timing when the signal C is changed from CA to CB. As a result, the control signal output circuit outputs, as the control signal, an OFF signal while the signal C is CB, “regardless of a magnitude relation between the boundary value TH and a current determination signal, in a case where the level is changed at the same level changing speed as that of when the signal C is CA even after the signal C is changed from CA to CB after the second change”.

Therefore, processing and outputting of a signal can be immediately switched off at a timing when the signal C is changed from CA to CB, that is, when incoming of a signal stops. Therefore, in addition to the effect of the above structure, processing and outputting of a signal can be promptly and efficiently switched off.

The control signal output circuit of an optical receiver of the embodiment may (a) generates a second determination signal in which a change in the signal C from CA to CB is delayed and (b) sets a boundary value Cth that the second determination signal passes, and after the second change, and even after the signal C changes from CA to CB, the control signal output circuit changes, during a period in which the second determination signal has not yet passed the boundary value Cth, the level of the determination signal at the same level change rate as in the period in which the signal C is CA, and the control signal output circuit changes, at a timing when the second determination signal passes the boundary value Cth, the level of the determination signal to be beyond the boundary value TH.

In the above structure, after the second change, even after the signal C is changed from CA to CB but before the second determination signal passes the boundary value Cth, the level of the determination signal is changed at the same level changing speed as that of when the signal C is CA. At a timing when the second determination signal passes the boundary value Cth, the level passes the boundary value TH.

Therefore, a control signal for switching off can be outputted before the determination signal spontaneously passes the boundary value. In addition, although the signal C fluctuates, a control signal for switching off can be stably outputted without being affected by the fluctuation. Therefore, in addition to the effect of the above structure, quickness and stability can be improved in a balanced manner.

Further, an optical receiver of the embodiment may include; a resistor and a capacitor, which are connected to the light sensing device so that the light sensing device and the signal process circuit are connected via the capacitor; and a switching element between the capacitor and the signal process circuit, the switching element being switched over by the activation control circuit so as to be grounded during a standby mode.

In the above structure, a resistor and a capacitor are connected to the light sensing device, and the light sensing device is connected to the signal process circuit via the capacitor. Therefore, in addition to the effect of the above structure, the resistor and the capacitor can function as a low-frequency/high-frequency current divider filter.

Further, across the capacitor and the signal process circuit, a switching element that can switch the activation control circuit to be connected to the ground during a standby mode is connected, thereby effectively preventing an unnecessary signal from entering the signal process circuit during the standby mode, in addition to the effect of the above structure.

Further, in an optical receiver of the embodiment, the activation control circuit may include a time-constant-predetermined hysteresis circuit for which a time constant is predetermined. Further, the time-constant-predetermined hysteresis circuit may be connected across that section in the activation control circuit which determines which one of the signal CA and the signal CB is outputted as the signal C.

In the above structure, a time-constant-predetermined hysteresis circuit in which a time constant is arbitrarily predetermined is connected across that section in the activation control circuit which determines which one of the signal CA and the signal CB is outputted as the signal C. This allows a certain period of dead time to be set when the signal C is changed between CA and CB, thereby giving no influences to other elements when the signal C fluctuates during the period. Therefore, in addition to the effects of the above structure, error operation during a change of the signal C between CA and CB can be effectively prevented.

Further, an optical receiver of the embodiment may include a dummy light sensing device connected in parallel to the light sensing device, the dummy light sensing device having the same area as that of the light sensing device and including a cathode electrode shielding a light receiving section thereof.

In the above structure, a dummy light sensing device having the same area as the light sensing device and including a cathode electrode whose light sensing section is shielded, is connected in parallel to a light sensing device that is not the dummy light sensing device. Therefore, in addition to the effect of the above structure, when, for example, electromagnetic noise or power line noise, other than an optical signal, enters the optical receiver, common-mode noise are included by both the dummy light sensing device and the light sensing device. However, the common-mode noise can be removed by the differential amplifier, thereby reducing noise and achieving excellent receiving.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. An optical receiver comprising:
a signal process circuit that carries out an output process of data received by a light sensing device;
an activation control circuit, (a) for determining, based upon a level of a voltage of a low-frequency current component of a current signal generated by the light sensing device, whether or not data is being received, and (b) for outputting a signal C, which, when data is being received, is a signal CA indicating that data is being received, so that the output of the signal CA activates the signal process circuit, and when no data is being received, is a signal CB indicating that no data is being received;
an operation determining circuit for determining, based upon a level of an output signal of the signal process circuit, whether or not data is being received, and outputs a signal G which, when data is being received, is a signal GA indicating that data is being received and when no data is being received, is a signal GB indicating that no data is being received;
a control signal output circuit for outputting a control signal according to comparison between a predetermined boundary value TH and a determination signal that the control signal output circuit generates, the control signal being such that at least in a period in which the signal C is CA, the control signal is an ON signal if the comparison shows that a direction from the boundary value TH to the determining signal currently generated is a direction D1, or is an OFF signal if the comparison shows that the direction from the boundary value TH to the determining signal currently generated is a direction D2, where the direction D1 is one of an increasing direction and a decreasing direction and the direction D2 is the other one of the increasing direction and the decreasing direction, and where (a) if in the period in which the signal C is CA, a first change occurs that is a change of the signal G from GB to GA, the determination signal changes a level thereof in the direction D1 at such a level change rate that the level of the determination signal is changed at least beyond the boundary value TH within the period in which the signal C is CA, (b) if a second change occurs that is a change of the signal G from GA to GB after the first change, the determination signal changes the level thereof, at least within the period in which the signal C is CA, in the direction D1 if the signal G is GA or in the direction D2 if the signal G is GB, but the determination signal changes the level thereof at such a level change rate that the level of the determination signal is changed not beyond the boundary value TH within the period in which the signal C is CA, and (c) after the second change, the determination signal changes the level thereof so that the level of the determination signal is beyond the boundary value TH after the signal C changes from CA to CB; and
an output control circuit for switching, according to the control signal from the control signal output circuit, whether or not the optical receiver outputs an output signal of the signal process circuit therefrom.

2. An optical receiver as set forth in claim 1, wherein
after the second change, and even after the signal C changes from CA to CB, the control signal output circuit changes the level of the determination signal at the same level change rate that the level of the determination signal is changed at least beyond the boundary value TH within the period in which the signal C is CA

3. An optical receiver as set forth in claim 1, wherein
after the second change, the control signal output circuit changes, at a timing when the signal C is changed from CA to CB, the level of the determination signal to be beyond the boundary value TH.

4. An optical receiver as set forth in claim 1, wherein
the control signal output circuit (a) generates a second determination signal in which a change in the signal C from CA to CB is delayed and (b) sets a boundary value Cth that the second determination signal passes, and
after the second change, and even after the signal C changes from CA to CB, the control signal output circuit changes, during a period in which the second determination signal has not yet passed the boundary value Cth, the level of the determination signal at the same level change rate as in the period in which the signal C is CA, and the control signal output circuit changes, at a timing when the second determination signal passes the boundary value Cth, the level of the determination signal to be beyond the boundary value TH.

5. An optical receiver as set forth in claim 1, comprising:
a resistor and a capacitor, which are connected to the light sensing device so that the light sensing device and the signal process circuit are connected via the capacitor; and
a switching element between the capacitor and the signal process circuit, the switching element being switched over by the activation control circuit so as to be grounded during a standby mode.

6. An optical receiver as set forth in claim 5, comprising
a time-constant-predetermined hysteresis circuit connected across that section in the activation control circuit which determines which one of the signal CA and the signal CB is outputted as the signal C.

7. An optical receiver as set forth in claim 1, comprising
a dummy light sensing device connected in parallel to the light sensing device, the dummy light sensing device having the same area as that of the light sensing device and including a cathode electrode shielding a light receiving section thereof.
